(19) United States
(12) Patent Application Publication
(10) Pub. No.: US 2009/0229683 A1
(43) Pub. Date: Sep. 17, 2009

(54) NON-CONTACT TYPE WATER LEVEL CONTROL APPARATUS

(75) Inventors: Ju-Hyun Baek, Seoul (KR); Kyu-Seob Ahn, Seoul (KR)

Correspondence Address: PERKINS COIE LLP, P.O. BOX 1208, SEATTLE, WA, 98111-1208, US

(73) Assignee: WOONGIN COWAY CO., LTD, CHOONGCHEONGNAM-DO (KR)

(21) Appl. No.: 12/374,783

(22) PCT Filed: Jul. 11, 2007
(86) PCT No.: PCT/KR07/03351

§ 371 Date: Jan. 22, 2009

(30) Foreign Application Priority Data
Jul. 27, 2006 (KR) 10-2006-0070708

(51) Int. Cl. B67D 5/00

(52) U.S. Cl. 137/386

(57) ABSTRACT

A water level control apparatus including: at least one capacitive sensor attached to an outer surface of a sidewall of a tank for storing water, the capacitive sensor sensing a capacitance change depending on whether water stored in the tank exists or not at the location where the capacitive sensor is attached; and a controller controlling an amount of water to be supplied to the tank according to the capacitance change sensed by the capacitive sensor.

### TECHNICAL FIELD

The present invention relates to a water level control apparatus and, more particularly, to a non-contact water level control apparatus measuring a water level in a purified water storage tank of a water purifier without being in direct contact with water, thereby controlling an amount of water to be supplied to the water storage tank.

### BACKGROUND ART

In general, a water purifier purifies water through various types of filter and stores the purified water above a certain level. When a user uses water from the water purifier and a water level descends, this will be sensed and water is supplied and purified to be stored. When water is stored to reach an appropriate level with respect to a capacity of the purified water storage tank, water should be blocked from being supplied to the purified water storage tank. That is, in order for the water purifier to stably supply purified water, it is important to maintain a constant level of the purified water in the purified water storage tank.

FIG. 1 is a schematic view illustrating a conventional water level control apparatus. As shown in FIG. 1, the conventional water level control apparatus employs a water level sensor 12 disposed inside a purified water storage tank 11, in direct contact with water. The water level sensor employed in the conventional water level control apparatus shown in FIG. 1 is one that is known as a lid level sensor detecting a water level through floating of an air bladder. That is, when water stored in the purified water storage tank is discharged by the user and the water level drops, the air bladder of the lid level sensor also drops and the water level control apparatus operates to supply water into the tank. Conversely, when the water level rises with water being supplied, the apparatus senses a location of the ascending air bladder. If the location of the air bladder reaches a predetermined level, the apparatus operates to block the water being supplied when the location of the air bladder reaches a certain level.

However, such a lid level sensor is vulnerable to impacts and likely to be damaged internally, which results in malfunction in detecting the water level. In addition, when the air bubbles are generated in the water stored in the purified water storage tank or the water stored in the storage may be inclined, the air bladder may not ascend properly, causing malfunction. In particular, the lid level sensor employed in the conventional water level sensor is in direct contact with water, which is linked to possibility of contamination of water. Also, it is disposed inside the storage tank in a protruded shape, hampering cleaning the inside of the tank.

In addition, the conventional water level control apparatus employs other types of water level detection sensors including a type of water level detection sensor having a mechanical air bladder which blocks a water inlet of the purified water storage tank as a water level rises, and a type of water level detection sensor having a non-contact type sensor module inserted into a tank to contact water directly. However, since these types of water level sensors are in direct contact with water inside the tank, they are highly likely to contaminate the purified water and hamper cleaning of the tank

### DISCLOSURE OF INVENTION

### Technical Problem

An aspect of the present invention provides a water level control apparatus detecting a water level of a purified water storage tank of a water purifier without being in direct contact with water, thereby preventing contamination of purified water and facilitating cleaning of the purified water storage tank.

### Technical Solution

According to an aspect of the invention, there is provided a water level control apparatus including: at least one capacitive sensor attached to an outer surface of a sidewall of a tank for storing water, the capacitive sensor sensing a capacitance change depending on whether water stored in the tank exists or not at the location where the capacitive sensor is attached; and a controller controlling an amount of water to be supplied to the tank according to the capacitance change sensed by the capacitive sensor.

The apparatus may further include a water level determiner determining whether the capacitance change sensed by the capacitive sensor is caused by a water level change or not, wherein the controller controls the amount of water to be supplied to the tank according to the capacitance change determined to be caused by the water level change by the water level determiner.

The water level determiner may include: an oscillator oscillating an oscillation frequency varying with the capacitance change sensed by the capacitive sensor; a rectifier rectifying and converting the oscillation frequency of the oscillator into a direct-current (DC) voltage; and a comparator comparing the DC voltage converted by the rectifier with a reference voltage and outputting a result of the comparison to the controller.

The at least one capacitive sensor and the water level determiner may be mounted on a single printed circuit board.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram illustrating a conventional water level control apparatus;

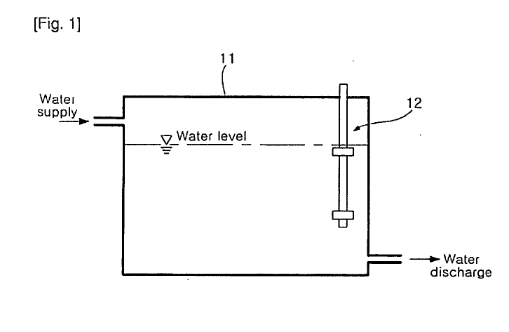

FIG. 2 is a schematic diagram illustrating a water level control apparatus according to an exemplary embodiment of the present invention; and

FIG. 3 is a block diagram illustrating a water level determiner according to an exemplary embodiment of the present invention.

### MODE FOR THE INVENTION

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity and the same reference numerals are used throughout to designate the substantially same or similar components. In the description of the invention, the terms are defined in consideration of the function of the invention and are thus subject to variation in meaning according to the intention or conventions of a person with ordinary skill in the art. Therefore, they should not be construed as limiting the technical components of the invention.

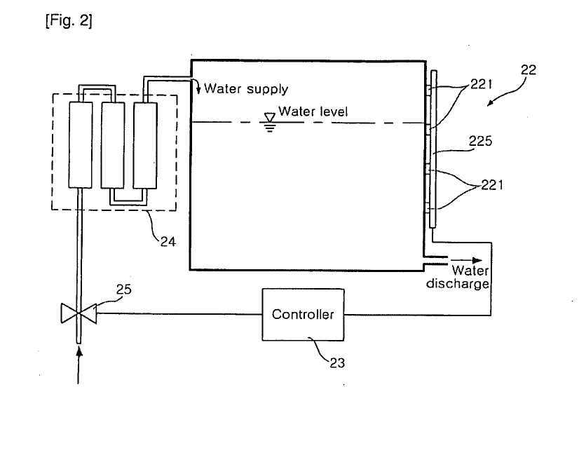

FIG. 2 is a schematic view illustrating a water level control apparatus according to an exemplary embodiment of the present invention.

As shown in FIG. 2, the water level control apparatus broadly includes at least one capacitive sensor 22 attached to an outer surface of a sidewall of a purified water storage tank (hereinafter, tank) 21 for storing water and a controller 23 controlling an amount of water to be supplied to the tank 21 according to a capacitance change sensed by the capacitive sensor 22. Although not shown in FIG. 2, the water level control apparatus may further include a water level determiner determining whether the capacitance change sensed by the capacitive sensor 22 is caused by a water level change or not.

The capacitive sensor 22 is also called a capacitive proximity sensor, an electrostatic sensor or a proximity sensor. When in contact with or in proximity to an object or a material having electric charges, the capacitive sensor 22 detects the amount of electric charges. That is, it is a sensor detecting a change in capacitance generated by the amount of electric charges of the object or the material in contact or in proximity.

The capacitive sensor 22 is attached to an outer surface of the sidewall of the tank 21. When water does not exist in the tank 21 or when the water level has not reached a location at which the capacitive sensor 22 is attached, no electric charges are sensed by the capacitive sensor 22. When water is supplied to the tank 21 and the water level rises to the location at which the capacitive sensor 22 is attached, the capacitive sensor 22 and water become adjacent to each other with the sidewall of the tank 21 in between. In this case, the capacitive sensor 22 detects the change in capacitance caused by the amount of electric charges of the water.

There may be only one capacitive sensor 22 installed corresponding to the highest water level possible of the tank. However, there may be provided a plurality of capacitive sensors 22 corresponding to respective water levels of the tank when there is a need to measure multiple levels of water.

The controller 23 determines the water level from the capacitance change sensed by the capacitive sensor 22, thereby controlling an amount of water to be supplied to the tank 21. For example, as shown in FIG. 2, in a water purifier equipped with a valve 25 for adjusting the amount of water to be supplied from the outside and a filter 24 for purifying the water supplied by operation of the valve 25 and supplying the purified water to the tank 21, the controller 23 may control the amount of water to be supplied by controlling the position of the valve 25. For example, when the water stored in the tank 21 reaches a desired level and the capacitive sensor 22 corresponding to the level senses a change in capacitance, the controller 23 may control the valve 25 to completely block the supply passage of water. Conversely, when the water level descends, the controller may control the valve 25 to completely open the supply passage of water.

The water level determiner, which is not shown in FIG. 2, determines whether the change in capacitance sensed by the capacitive sensor 22 is caused by a water level change. For example, the water level determiner may be provided to distinguish a capacitance change caused by one of malfunctions of the capacitive sensor 22 or water lapping inside the tank from a capacitance change caused by a rise of water level with water being supplied into the tank 21.

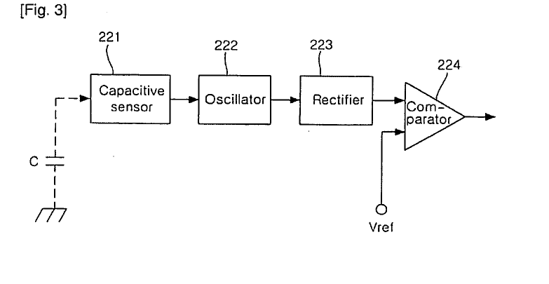

FIG. 3 is a block diagram illustrating the water level determiner of the water level control apparatus according to an exemplary embodiment of the present invention.

Referring to FIG. 3, the water level determiner 26 may include an oscillator 261, a rectifier 262 and a comparator 263.

The oscillator 261 generates an oscillation frequency varying with a change in capacitance C sensed by the capacitive sensor 22. The rectifier 261 rectifies and converts the oscillation frequency generated by the oscillator 261 into a direct-current (DC) voltage. For example, with a higher oscillation frequency, a magnitude of the converted DC voltage may be larger. The comparator 263 compares the magnitude of the DC voltage outputted from the rectifier 261 with a magnitude of a predetermined reference voltage Vref and outputs a result of the comparison. The comparison result of the comparator 263 is transmitted to the controller 23. The controller determines a water level according to the comparison result outputted from the comparator 263 and controls the amount of water to be supplied to the tank 21. For example, as a result of the comparison outputted from the comparator 263, when the DC voltage of the rectifier 262 is greater, the controller 23 may determine that the water level has risen up to a level at which the corresponding capacitive sensor 22 is located and control the supply of water to be blocked. On the other hand, as a result of the comparison outputted from the comparator 263, when the DC voltage of the rectifier 262 is smaller and the difference becomes a certain amount or more, the controller 23 may determine that the water level has descended below the level at which the corresponding capacitive sensor 22 is located and control the water to be supplied to the tank 21.

The capacitive sensor 22 and elements constituting the water level determiner 26 may be mounted on a single printed circuit board 27. That is, a desired number of capacitive sensors 22 with the components constituting the water level determiner 26 provided for each of the capacitive sensors 22 may be mounted on a single printed circuit board to realize one module. This module may be attached on an outer surface of the sidewall of the tank to determine the water level inside the tank.

The operations of the present invention will now be described in detail with reference to FIGS. 2 and 3.

When water is not stored in the tank, each of the capacitive sensors 22 does not sense any electric charge and thus senses no change in capacitance. Therefore, the oscillator 261 does not generate an oscillation frequency and the magnitude of the DC voltage outputted from the rectifier 262 may be 0 V. In this case, the comparator 263 determines that a voltage smaller than the reference voltage Vref is outputted from the rectifier and transmits a result of the determination to the controller 23.

The controller 23 determines that there is no electric discharge detected from all the capacitive sensors 22 and controls the valve 25 to completely open the supply passage of water. This allows water to be supplied from the outside, purified through the filter 24 and stored in the tank.

Next, as shown in FIG. 2, an example of operation, when it is desired to store water up to a level at which a second capacitive sensor 22 from the top of the tank is attached, will be described.

In the case that the valve 25 is controlled to open the supply passage of water to the tank 21, as water is continuously purified and stored up to the level at which the second capacitive sensor 22 from the top of the tank is attached, the second capacitive sensor 22 senses the amount of electric charges of the water and senses an increase in capacitance.

The oscillator 261 generates an oscillation frequency according to the increased capacitance, and the rectifier 262 generates a DC voltage corresponding to the oscillation frequency of the oscillator 261. The DC voltage generated from the oscillator 261 is compared with a predetermined reference voltage Vref by the comparator. The reference voltage Vref may be set somewhat smaller than the DC voltage generated by the rectifier 262 when the capacitive sensor 22 senses the amount of electric charges of water by the rise of water level. Therefore, when the capacitive sensor 22 senses the amount of electric charges of water by the rise of water level, the comparator 263 transmits a comparison result that the DC voltage generated by the rectifier 262 is greater than the reference voltage Vref.

The controller 23 recognizes from the information transmitted from the comparator 263 that the water level has risen to the level at which the second capacitive sensor is attached and controls the valve 25 to completely block the supply passage of water to maintain a desired water level in the tank 21.

As described above, the present invention employs the capacitive sensor installed on an outer surface of the sidewall of the tank, thereby simplifying the structure inside the tank. This facilitates cleaning inside the tank and prevents contamination of water due to contact between water and the sensor.

According to the present invention set forth above, a sensor is attached to an outer surface of the sidewall of the tank for storing water to detect a water level in the tank, thereby preventing contamination of purified water of a water purifier from direct contact between the sensor and the water.

In addition, the structure inside the tank is simplified to facilitate cleaning inside the tank.

Furthermore, as the sensor is attached to an outer surface of the sidewall of the tank in a dry environment, the sensor is prevented from malfunction and has semi-permanently increased lifetime.

While the present invention has been shown and described in connection with the exemplary embodiments, it will be apparent to those skilled in the art that modifications and variations may be made without departing from the spirit and scope of the invention as defined by the appended claims.

1. A water level control apparatus comprising:
at least one capacitive sensor attached to an outer surface of a sidewall of a tank for storing water, the capacitive sensor sensing a capacitance change depending on whether water stored in the tank exists or not at the location where the capacitive sensor is attached; and
a controller controlling an amount of water to be supplied to the tank according to the capacitance change sensed by the capacitive sensor.

2. The apparatus of claim 1, further comprising a water level determiner determining whether the capacitance change sensed by the capacitive sensor is caused by a water level change or not,
wherein the controller controls the amount of water to be supplied to the tank according to the capacitance change determined to be caused by the water level change by the water level determiner.

3. The apparatus of claim 2, wherein the water level determiner comprises: an oscillator oscillating an oscillation frequency varying with the capacitance change sensed by the capacitive sensor;
a rectifier rectifying and converting the oscillation frequency of the oscillator into a direct-current (DC) voltage; and
a comparator comparing the DC voltage converted by the rectifier with a reference voltage and outputting a result of the comparison to the controller.

4. The apparatus of claim 3, wherein the at least one capacitive sensor and the water level determiner are mounted on a single printed circuit board.
